(19) United States
(12) Patent Application Publication
(10) Pub. No.: US 2010/0189859 A1
(43) Pub. Date: Jul. 29, 2010

(54) DEVICE AND PROCESS FOR BREWING A DRINK

(75) Inventors: Jean-Pierre Blanc, Nice (FR); Christian Ferrier, Nice (FR)

Correspondence Address: YOUNG & THOMPSON, 209 Madison Street, Suite 500, Alexandria, VA, 22314, US

(73) Assignee: COMPAGNIE MEDITERRANEENE DES CAFES S.A., CARROS (FR)

(21) Appl. No.: 12/375,168

(22) PCT Filed: Jul. 25, 2007
(86) PCT No.: PCT/EP07/57642

§ 371 Date: Mar. 22, 2010

(30) Foreign Application Priority Data
Jul. 26, 2006 (FR) 0606818

(51) Int. Cl. A47J 31/00; A47J 31/40; B65B 29/02

(52) U.S. Cl. 426/394; 99/295; 99/289 R

(57) ABSTRACT

A device and process for brewing drinks, the device includes a brewing chamber capable of accommodating a package containing products to be brewed, the chamber having two parts configured so as to be moved towards or away from each other to close or open, respectively, the brewing chamber, and package arresting elements capable of applying themselves around the perimeter of the package once introduced into the brewing chamber. According to the invention, the device is such that one of the parts of the brewing chamber is mobile, allowing it to move the package past the arresting elements by deforming the perimeter of the package. Applicable to espresso type coffee machines.

The present invention relates to a device for producing drinks by brewing a product contained in a package.

It is particularly applicable to espresso type coffee machines. It can also apply to the production of drinks from other substances such as tea.

Coffee machines, especially domestic ones, have changed very significantly during the past decade. Indeed, single disposable packages of ground coffee have developed considerably so as to facilitate the use of coffee machines. The user no longer has any contact with the ground coffee, which greatly facilitates the manipulation of the ground coffee and allows the drink to be produced more cleanly.

Document WO-A-9517121 by the same applicant has already proposed an automatic machine for brewing hot drinks comprising a fixed part and a mobile part capable of being moved towards or away from each other to close or open a brewing chamber in the centre of which is received a package containing ground coffee. In the case of this prior art, the package is introduced by guiding by means of two slides capable of holding the package in a substantially vertical position by its perimeter. A stop is also provided in the lower position of the brewing chamber so as to retain the package or allow its ejection by gravity when the stop is retracted.

This machine is satisfactory overall and in particular ensures very practical usage by the method of introduction and ejection it implements. However, it uses a plurality of mechanical components which form a fairly complex kinematic assembly.

Document WO 2005/004683-A1- presents a device for the removal of capsules.

According to one possibility, the capsule is held by a retractable stop system which leads to the same drawbacks as WO-A-9517121.

According to another possibility, this device takes advantage of the conical shape of the capsule to move it downwards when it is pushed longitudinally. The system involves the use of a double movement for the capsule which is complex and can only be achieved with very specific capsules.

There is therefore a need to propose an improved device for producing drinks, particularly to simplify the coaction between the package and the brewing chamber during the production of drinks, in particular during the phases of introduction, brewing and ejection.

The present invention falls within this context and for this purpose it proposes a device and a process in which the package can be removed from the arresting means which hold it in the introduced position, by deforming its perimeter. According to the state of the technique it is generally thought that it is the removal of the stop in relation to the package which allows ejection by gravity. On the contrary, according to the invention, the arresting means and the package are released from one another by deformation of the package itself.

In a preferred case, it is one of the parts of the brewing chamber which pushes the package so as to force it out of the arresting means by deformation of its perimeter. In this case, the only mobile component is the corresponding part of the brewing chamber which is capable of pushing on the package. This pushing phase also advantageously allows the closure of the brewing chamber so that a single translation movement is sufficient to accomplish the phases of positioning, closure and opening of the brewing chamber and then ejection of the package. The force pushing on the package is applied along the axis of the brewing chamber, according to the direction of movement towards and away from each other of the two parts of said chamber. This movement blocks the retention of the arresting means which are advantageously oriented perpendicular to the pushing direction.

Other advantageous aims will appear during the following description which presents a preferred embodiment of the invention which however is not restrictive.

First of all, it is recalled that the invention concerns a device for producing drinks by brewing a product contained in a package, comprising:

a brewing chamber capable of receiving the package, the said chamber comprising two parts configured to move towards or away from each other to close or open, respectively, the brewing chamber;

arresting means for package which are capable of applying themselves on the perimeter of the package in an introduced position into the brewing chamber,

characterised in that one of the parts of the brewing chamber is mobile, allowing it to move the package past the arresting means by deforming the perimeter of the package.

According to preferred but not restrictive embodiments, this device may be such that:

the mobility of the mobile part of the brewing chamber consists in translation in a direction perpendicular to the orientation of the package in an introduced position into the brewing chamber.

the arresting means are fixed and the package is moved by the mobile part in relation to the arresting means.

the arresting means comprise a stop surface preventing the package from falling by gravity and a lateral guide surface.

the lateral guide surface is formed by a pair of grooves capable of coacting with two parts of the perimeter of the package.

the stop surface and the lateral guide surface are formed in the same part or parts having two directions of application on the perimeter of the package.

two slides have a first grooved part for lateral guiding of the package and a second stop part, the said first and second parts of the slide forming a non-zero-angle.

the deformation caused by the mobility of the mobile part of the brewing chamber is an elastic deformation.

the introduced position of the package is oriented vertically.

the mobility of the mobile part of the brewing chamber ensures the closure of the brewing chamber.

it comprises a return mean for the package outside the second part of the brewing chamber when the mobile part is away from the second part.

it comprises a follower unit driven by the mobile part and provided with at least one groove configured to receive the perimeter of the package when the latter has moved past the arresting means.

the travel of the follower unit is shorter than that of the package in order to move it past the arresting means and so that it is received in the grooves.

the follower unit comprises two grooves oriented parallel to the guide surface.

the follower unit is mounted against elastic return means.

each groove is partially delimited by a surface of the follower unit on which the perimeter of the package can be applied under the action of the mobile part.

The invention also concerns a process for producing drinks by brewing a product contained in a package in which:

the package is introduced into a brewing chamber comprising two parts configured to be moved towards or away from each other to close or open, respectively, the brewing chamber;

the package is fixed in position once it has been introduced into the brewing chamber by applying arresting means on its perimeter;

characterised in that one of the parts of the brewing chamber is moved in such a way as to move the package past the arresting means by deformation of the perimeter of the package.

According to preferred but not restrictive variants, this process is such that:

by the movement on the mobile part, a push is exerted on the package.

the movement of the mobile part is continued so as to move the package towards the second part of the brewing chamber and to close the brewing chamber.

the package is introduced in a roughly vertical direction.

a package is used that presents an elastically deformable perimeter.

the package comprises a flattened perimeter surrounding a packaging volume of product to be brewed.

the perimeter comprises a central reinforcement made of plastic or cardboard.

The attached drawings are given as examples and are not restrictive for the invention. They only represent embodiments of the invention and will allow it to be easily understood.

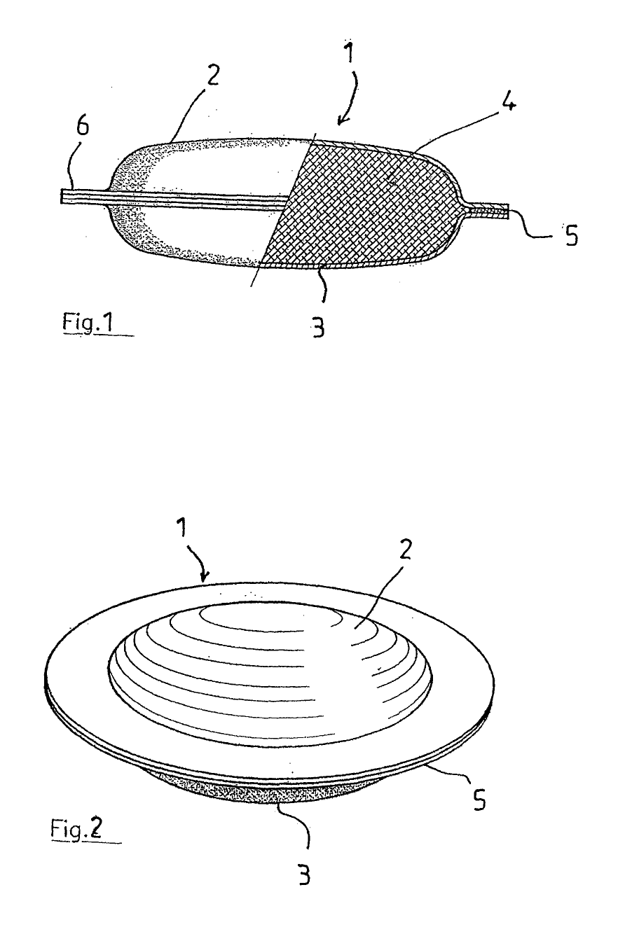

FIG. 1 shows an example in side view and partial sectional view of a package that can be used in the context of the present invention; FIG. 2 shows a perspective view of it.

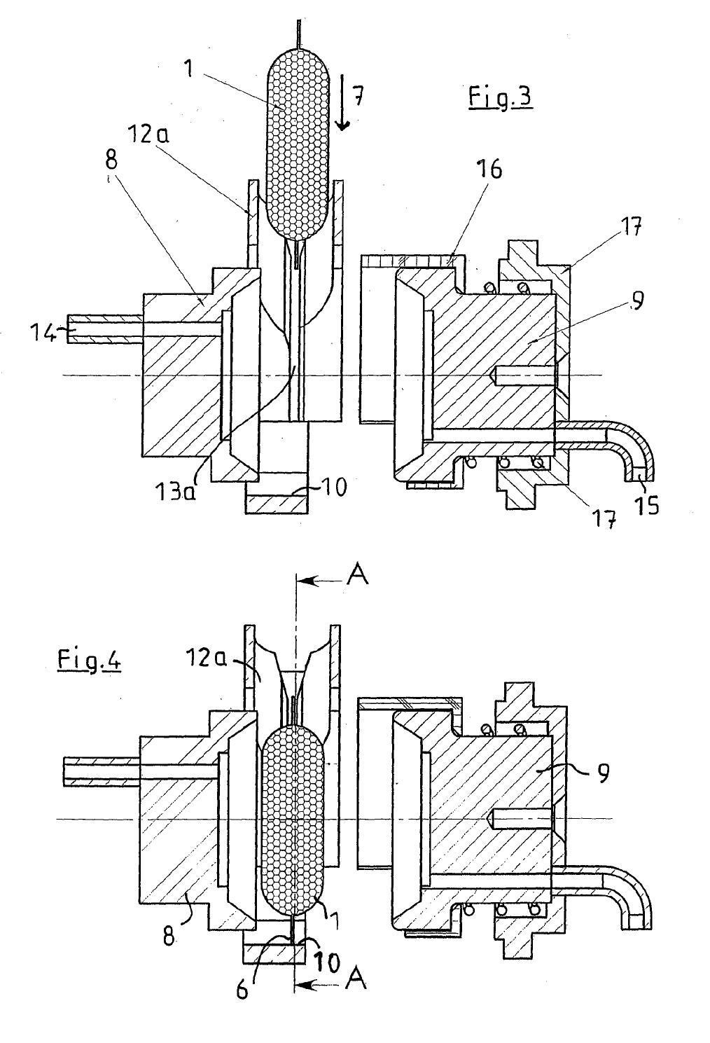

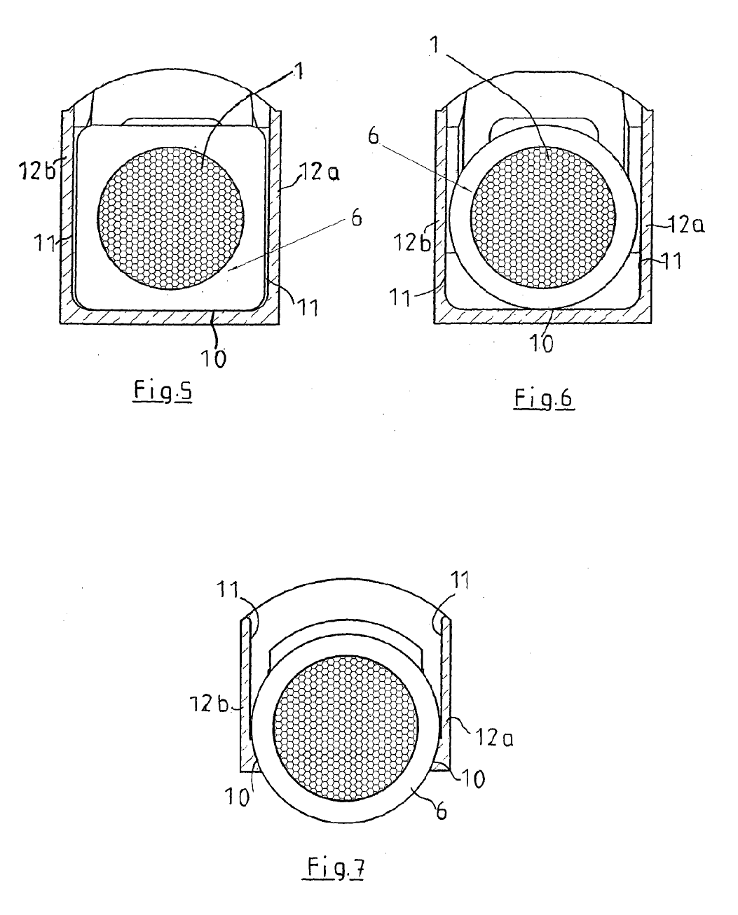

FIG. 3 shows in longitudinal section the invention device in an embodiment with a phase of package introduction.

FIG. 4 shows this same device in a successive phase in which the package is in the introduced position in a brewing chamber.

FIGS. 5 to 7 show three variants of the coaction between the package and the arresting means, FIG. 5 showing a package presenting a substantially square perimeter while FIGS. 6 and 7 show a package with circular perimeter.

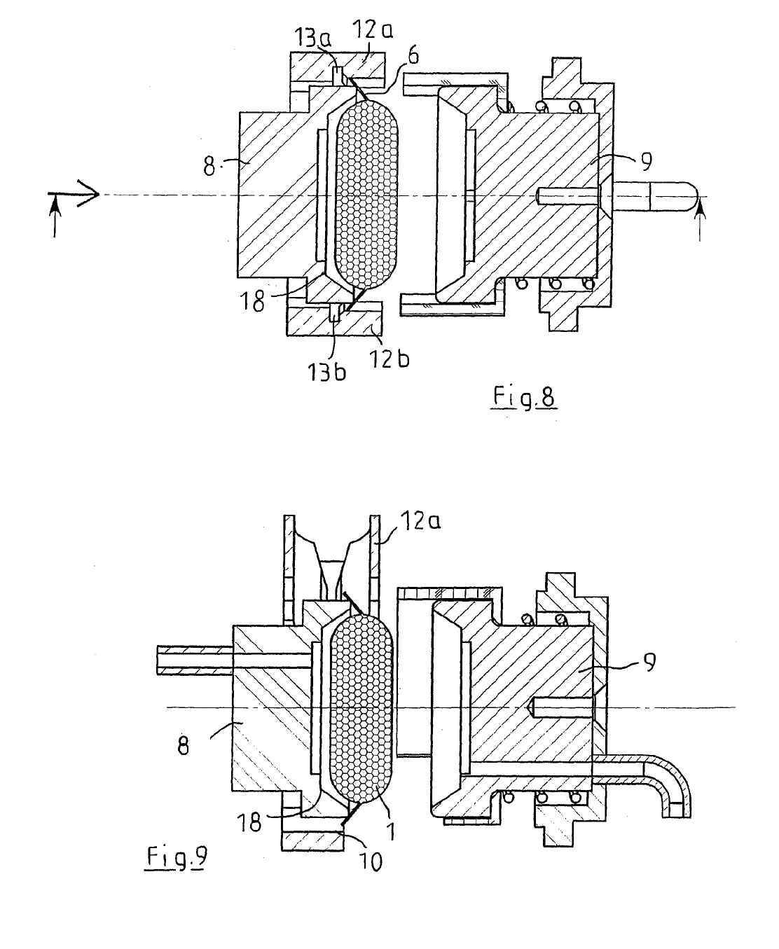

FIG. 8 shows in cross section a later phase of operation in which the package is moved relative to the arresting means so as to extract it.

FIG. 9 shows a cross sectional view of this same phase.

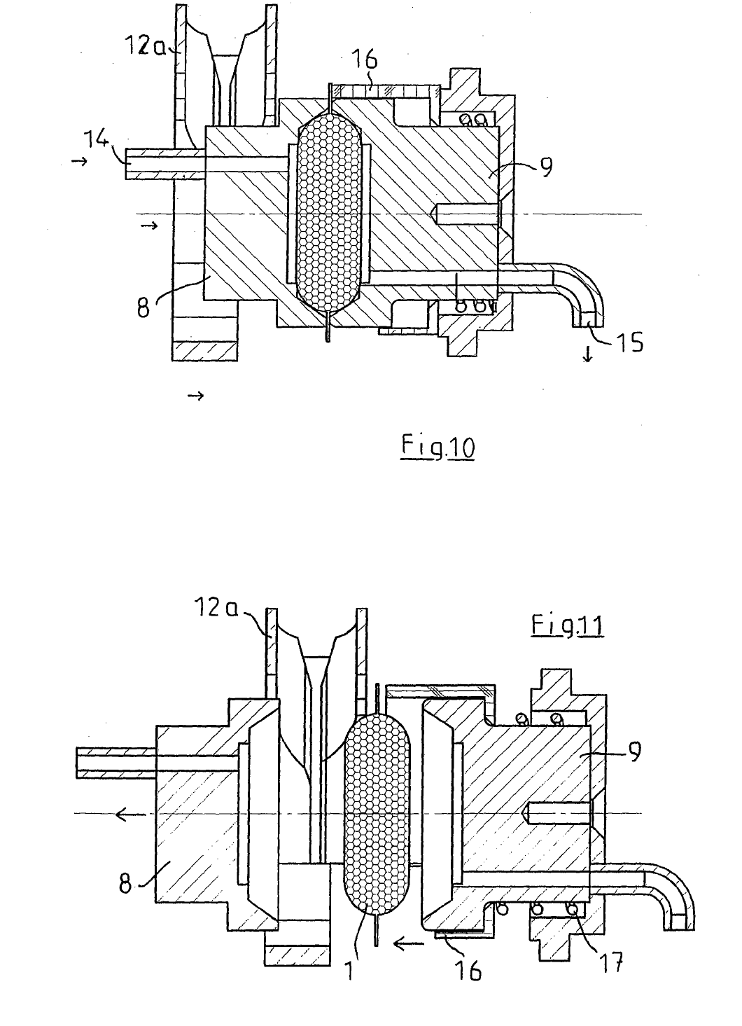

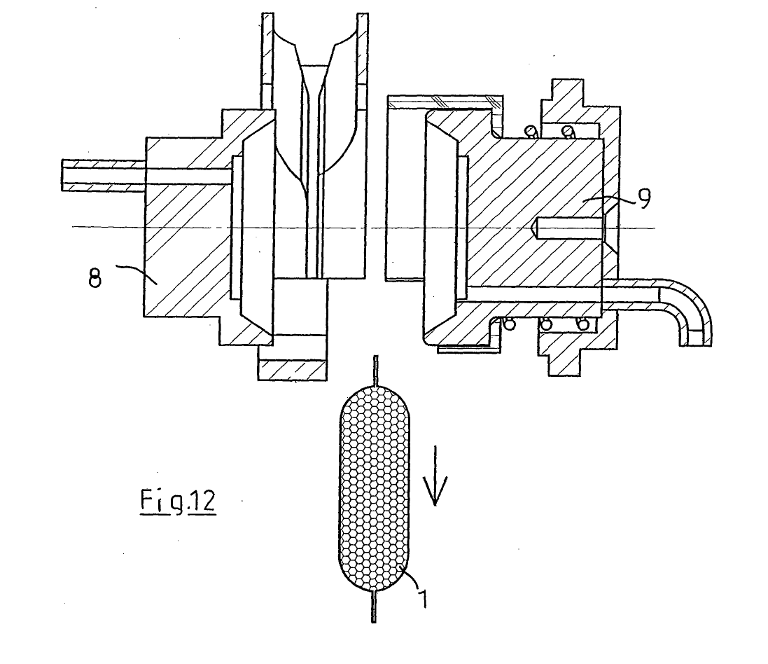

FIG. 10 shows, in longitudinal section, the brewing chamber in the closed position.

FIG. 11 illustrates a following phase of operation in which the package is released both from the arresting means and from the parts of the brewing chamber in such a way as to eject it.

FIG. 12 illustrates the ejection of the package by gravity.

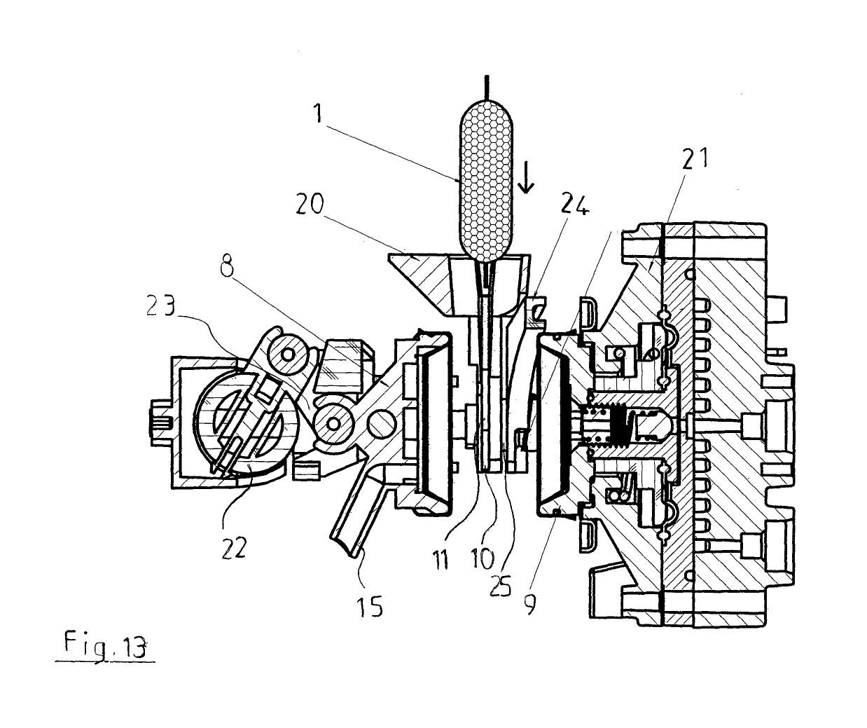

FIGS. 13 to 17 illustrate a variant of the preceding embodiment with a follower unit, according to successive phases of production of a drink.

The present invention can be used with packages of the type presented in FIGS. 1 and 2 although this example is not restrictive. According to these figures, the product to be brewed 4, for example ground coffee, is enclosed within the inner volume of package 1 constituted by the assembly of two layers 2, 3, joined at their periphery by a perimeter 6. On perimeter 6, between the two layers 2, a reinforcement 5 is advantageously made of cardboard covered with a plastic film on its two sides or else of plastic. The assembly proposed here is symmetrical but this is not restrictive for the invention which may be used with other packages.

Layers 2, 3, are advantageously made of filter paper so as to constitute the filtering material of product to be brewed 4. It would also be possible to form these layers impermeably so that they can be pierced during the brewing phase.

Perimeter 6 of package 1 is configured so as to be advantageously elastically deformable when it undergoes moderate pressure along a direction perpendicular to the seal face of layers 2, 3. Elastic deformation means a reversible type deformation, that is, in which perimeter 6 returns to its initial position after its deformation. As an example, the perimeter may have a width of the order of 6 mm and grooves 13a and 13b, described below, a depth of around 2 to 3 mm. Irreversible deformation could also be envisaged without leaving the context of the invention.

Furthermore, FIGS. 1 and 2 show a package with a circular perimeter, perimeter 6 being annular in shape, but it is also possible to create a package having a perimeter of another kind such as that illustrated in FIG. 5 in which the reception volume of the product to be brewed has a substantially circular section but perimeter 6 presents a substantially square border with rounded edges.

In general, it is possible to use a package of the type described in document WOA9507041.

We describe below the operation of the invention device with introduction of package 1 in a direction 7 which is substantially vertical whereas the longitudinal axis of the brewing chamber is substantially horizontal. However, this configuration is not restrictive and in particular it can be oriented obliquely.

FIG. 3 shows an invention device with a brewing chamber created by two parts 8, 9, at least one of which is mobile.

The figures show a mobile part 8 while second part 9 is fixed. Second part 9 could however be mobile. Parts 8, 9 are capable of moving towards or away from each other, allowing closure and opening of the brewing chamber. In the example illustrated, only the part 8 is mobile, in a horizontal translation movement.

The movement of mobile part 8 can be generated by any usual means including manual actuation of a lever connected to mobile part 8 by power transmission means, for example a toggle lever, motorisation, for example with a worm screw, or a pneumatic or hydraulic cylinder.

In the illustrations, mobile part 8 has a water inlet 14 capable of receiving the discharge of a hot water circuit from a tank using a pump and boiler system. The second part 9 presents a drinks outlet 15. In the closed position, parts 8, 9 delimit a reception volume for package 1 which is leaktight. The tightness may be achieved by application of the perimeters of parts 8, 9 on to perimeter 6 of package 1 forming a seal or by inserted sealing means.

FIG. 3 shows a phase of introduction of package 1 in direction 7. During this phase, package 1 is guided so as to remain substantially vertical by means of a lateral guide surface 11 which is formed here in slides 12a, 12b, themselves formed on either side of the brewing chamber with a vertical orientation. Slides 12a, 12b each comprise a groove 13a, 13b capable of cooperating with perimeter 6 of package 1, so forming guide surfaces 11.

In the introduction phase, package 1 is thus guided until it reaches a stop surface 10 shown in FIG. 3 by a flat part located below slides 12a, 12b, so as to receive the lower border of perimeter 6 of package 1.

Both this stop surface 10 and this lateral guide surface 11 form means arresting package 1. These arresting means coact with package 1 in the introduction phase and in the introduced position of the package as can be seen in FIG. 4.

In this position, the arresting means maintain the vertical orientation of package 1.

FIGS. 5 to 7 illustrate variants for executing the arresting means particularly according to the configuration of perimeter 6 of package 1. Thus, FIG. 5 shows a square configuration coacting with a lower stop surface 10 and a lateral guide surface 11 formed in two parts, firstly in a slide 12a and secondly in a slide 12b, formed on either side of the vertical borders of perimeter 6.

FIG. 6 shows a similar configuration of stop surface 10 and lateral guide surface 11 but coacting with a perimeter 6 of circular shape.

FIG. 7 shows another possibility for the execution of surfaces 10 and 11 using the same part for the execution of these two surfaces on either side of package 1. More precisely, slides 12a, 12b comprise a vertical portion forming a lateral guide surface 11 and an oblique part forming stop surface 10. The angle achieved between surfaces 10 and 11 ensures the retention of package 1 along two orientations so as both to maintain it vertically and to prevent it from falling.

As indicated earlier, part 8 is advantageously mobile in translation and, in the case shown, makes it possible to apply a pushing force on package 1. This pushing forces perimeter 6 of package 1 outside the arresting means and particularly outside lateral guide surfaces 11, for example formed by grooves 13a, 13b shown in FIG. 8. According to one possibility which is not illustrated, mobile part 8 does not move package 1 but the arresting means.

In the embodiment illustrated, the force pushing part 8 is horizontal and moves package 1 which is extracted from grooves 13a, 13b. At the same time, package 1 coacts with cup-shaped portion 18 of part 8. Advantageously, the cup has substantially a shape which cooperates with the shape of one of the surfaces of package 1. In this phase, mobile part 8 takes over maintaining package 1 in position. FIG. 9 shows a longitudinal view of the pushing phase corresponding to FIG. 8.

The clearance between parts 8 and 9 of the brewing chamber will be adjusted so as to prevent package 1 from falling by gravity during the brewing chamber closure phase between the exiting of perimeter 6 from the arresting means and fitting on part 9.

The continued movement of mobile part 8 makes it possible to reach the position illustrated in FIG. 10 in which the brewing chamber is closed and the fluid can circulate from water inlet 14 to drink outlet 15 to make a conventional infusion.

It will be noted that, in this position, package 1 is offset longitudinally in relation to the arresting means.

FIG. 11 illustrates a retraction movement of mobile part 8 which is capable of re-opening the brewing chamber and releasing package 1. As the latter is offset longitudinally in relation to the arresting means, it can be removed by simple gravity.

Advantageously, a return means 16 is used to prevent package 1 from being retained by adhesion after its application against the part 9.

In the example illustrated, return means 16 consists of an application surface on perimeter 6 of package 1 in opposition to the closure movement of the brewing chamber. During pushing of mobile part 8, return means 16 press against a spring 17 until it reaches a retracted position shown in FIG. 10.

When part 8 is retracted, return means 16 returns to position and induces a movement of separation between package 1 and part 9. In this way, no risk of sticking occurs between package 1 and part 9.

Therefore, package 1 falls very reliably as shown in FIG. 12.

It will be noted that all these phases take place with a single longitudinal translation movement both of mobile part 8 and package 1. No other mobility than that of part 8 is necessary for the performance of all the brewing chamber opening and closure phases. This greatly simplifies the design of the assembly and the choice of the means for activating mobile part 8.

We describe below a second embodiment of the device of the invention with reference to FIGS. 13 to 17.

As in the preceding case, a mobile part 8 and a second part 9 are operated opposite each other. Mobile part 8 is actuated in translation in the longitudinal direction of the device by a mechanical power transmission device using a shaft 22 and a connecting rod 23. The rotation drive of shaft 22 by the hinged action of connecting rod 23 moves mobile part 8 towards or away from part 9. The movement of mobile part 8 is advantageously guided along two rods 28a, 28b which are parallel to the longitudinal axis.

The arresting means are constituted in a manner similar to the illustration in FIG. 7 and comprise two slide components on either side of a volume receiving package 1 and making it possible to apply onto perimeter 6 of package 1 at a place different from the lowest part of perimeter 6. Hence no obstacle is formed below package 1.

In the embodiment on FIGS. 13 to 17, a follower unit advantageously common to the two lateral parts of the device is used. This follower unit moves in a similar manner to package 1 by the action of mobile part 8 and has a bearing surface 26 capable of applying itself to perimeter 6 of package 1 in order to move it away from part 9 of the brewing chamber when brewing has ended. In doing so follower unit 24 replaces return means 16 in the preceding embodiment.

Preferably, follower unit 24 has a surface forming the front surface of grooves 13a, 13b of lateral guide surface 11 of the arresting means. The arresting means are then formed partly in a fixed component which in this case is connected to a pod introduction orifice 20 and partly in a mobile component formed by follower unit 24.

In addition or alternatively, follower unit 24 may have one or advantageously two grooves 25 configured to receive perimeter 6 of package 1 when the latter has passed the arresting means. An assembly with two successive positions for package 1 is thus formed. A first position, corresponding to the introduction plane of package 1 in relation to the machine's axis, is defined by the arresting means. A second position located in a plane parallel to the preceding one but brought closer to part 9 of the brewing chamber is defined by grooves 25 of follower unit 24 and moves towards second part 9 during the actuation of mobile part 8.

It can easily be understood that groove or grooves 25 serve to guide the package once it has passed the arresting means during the phase of fitting on second part 9, of brewing, and of retraction of mobile part 8 causing the ejection of package 1 outside part 9 by return of follower unit 24 to its position. This return is achieved by the return means illustrated here in the form of two springs 27 opposite which follower unit 24 is fitted in translation on rods 28a, 28b.

FIGS. 13 to 17 show successive phases of device use. In FIG. 3, package 1 is introduced into an orifice 20 which in this case forms a single part with the rear surface of grooves 13a, 13b constituting the lateral guide surface of the stop means. At the end of introduction, perimeter 6 of package 1 is applied to stop surface 10 thereby preventing it from falling by gravity and is guided by lateral surface 11. According to a preferred embodiment, the front surface of lateral guide surface 11 is executed on follower unit 24.

When shaft 22 is actuated in rotation, mobile part 8 is moved in translation along a longitudinal axis in relation to the device. Mobile part 8 applies on package 1 and drives it as well as follower unit 24.

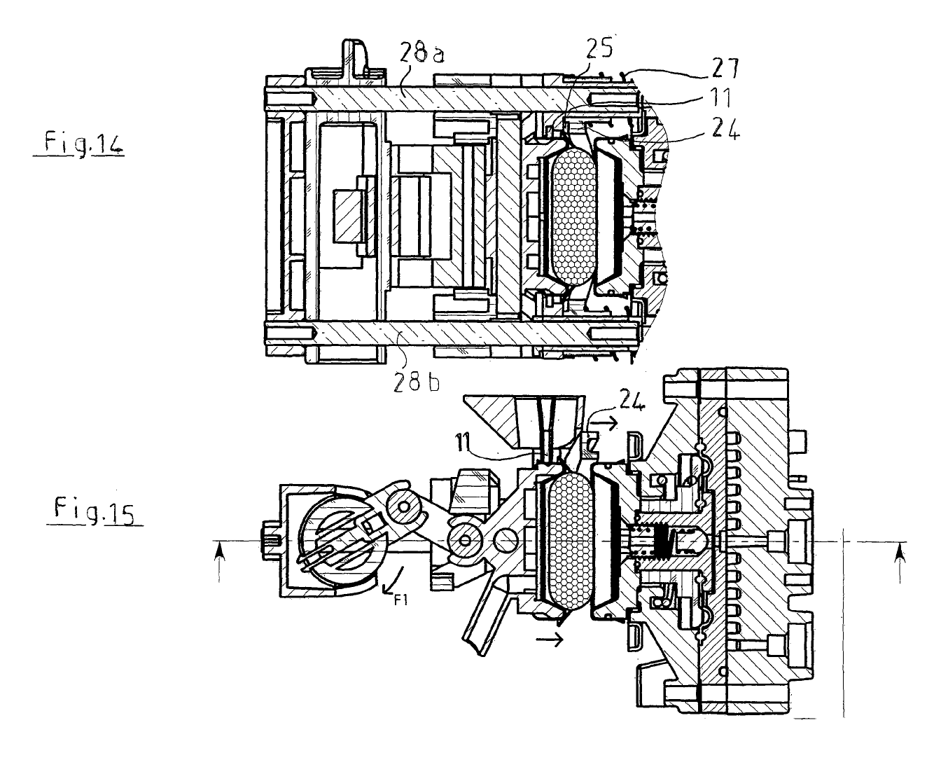

This progressive movement is illustrated in FIGS. 14 and 15 in which we observe deformation of the perimeter of package 1 so that it is released from lateral guide surface 11 until it reaches grooves 25 formed on follower unit 24.

Perimeter 6, which is first pressed against follower unit 24 that its movement drives, and then moves in the direction of grooves 25 when the follower unit is at the end of its travel.

During these phases, return means 27 are compressed.

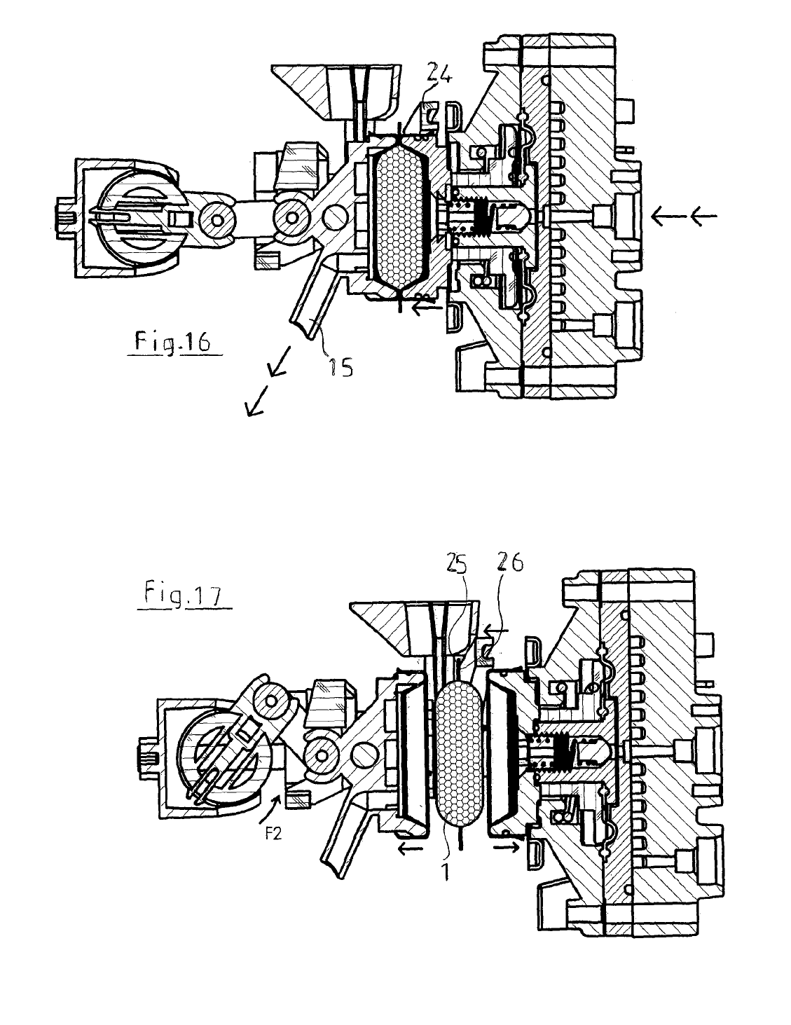

The beverage production phase is illustrated on FIG. 16, which very clearly shows that package 1 has been released from the arresting means.

At the end of the cycle, mobile part 8 is away from the part 9 which, under the effect of the springs 27, generates a return of follower unit 24 and consequently of package 1 since the latter is held in grooves 25.

Package 1 is now held in a position offset relative to the arresting means so that nothing prevents it from falling by gravity.

### REFERENCES

1—package
2—layer
3—layer
4—product to be brewed
5—reinforcement
6—perimeter
7—introduction direction
8—mobile part
9—second part
10—stop surface
11—lateral guide surface
12a, 12b—slide
13a, 13b—groove
14—water inlet
15—drink outlet
16—return means
17—spring
18—cup
20—orifice
21—body
22—shaft
23—connecting rod
24—follower unit
25—groove
26—bearing surface
27—spring
28—rod

1. Device for producing drinks by brewing a product contained in a package (1), comprising:
a brewing chamber capable of receiving package (1), the said chamber comprising two parts configured to move towards or away from each other, respectively to close or open the brewing chamber;
arresting means for package (1) capable of applying on perimeter (6) of package (1) in an introduced position into the brewing chamber and comprising a stop surface (10) preventing package (1) from falling by gravity and a lateral guide surface (11)
characterised in that one of the parts of the brewing chamber is mobile so that it is capable of moving package (1) past lateral guide surface (11) by deformation of perimeter (6) of package (1) and beyond the stop surface.

2. Device according to claim 1 in which the mobility of mobile part (8) of the brewing chamber is of a translation in a direction perpendicular to the orientation of package (1) in an introduced position into the brewing chamber.

3. Device according to claim 1 in which lateral guide surface (11) is formed by a pair of grooves (13a, 13b) which are capable of coacting with two parts of perimeter (6) of package (1).

4. Device according to claim 1 in which stop surface (10) and lateral guide surface (11) are formed in the same part or parts having two directions of application on perimeter (6) of package (1).

5. Device according to claim 4 comprising two slides having a first grooved part for lateral guiding of package (1) and a second stop part, the said first and second parts of the slide forming a non-zero angle.

6. Device according to claim 1 in which the arresting means are fixed and package (1) is moved by mobile part (8) in relation to the arresting means.

7. Device according to claim 3 comprising a follower unit (24) driven by mobile part (8) and provided with at least one groove (25) configured to receive the perimeter of package (1) when the latter has moved past the arresting means.

8. Device according to claim 7 in which the travel of follower unit (24) is shorter than that of package (1) so as to move it past the arresting means and so that it is received in grooves (25).

9. Device according to claim 7 in which follower unit (24) comprises two grooves (25) oriented parallel to guide surface (11).

10. Device according to claim 7 in which follower unit (24) is mounted against elastic return means.

11. Device according to claim 7 in which each groove (13a, 13b) is partially delimited by a surface of follower unit (24) on which perimeter (6) of package (1) may be applied under the action of mobile part (8).

12. Device according to claim 1 in which the deformation caused by the mobility of mobile part (8) of the brewing chamber is an elastic deformation.

13. Device according to claim 1 in which the introduced position of the package is oriented vertically.

14. Device according to claim 1 in which the mobility of mobile part (8) of the brewing chamber ensures the closure of the brewing chamber.

15. Device according to claim 14 comprising a return means (16, 24) for package (1) outside second part (9) of the brewing chamber when mobile part (8) is away from second part (9).

16. Process for producing drinks by brewing a product contained in a package (1) in which:
package (1) is introduced into a brewing chamber comprising two parts configured to be moved towards or away from each other, respectively to close or open the brewing chamber;
package (1) is fixed in position once it has been introduced into the brewing chamber by applying on its perimeter arresting means (6) comprising a stop surface (10) preventing package (1) from falling by gravity and a lateral guide surface (11)
characterised in that one of the parts of the brewing chamber is moved so as to move package (1) past the lateral guide surface by deformation of perimeter (6) of package (1) and past the stop surface.

17. Process according to claim 16 in which, by the movement on mobile part (8), a push is exerted on package (1).

18. Process according to claim 17 in which the movement of mobile part (8) is continued so as to move package (1) towards second part (9) of the brewing chamber and to close the brewing chamber.

19. Process according to claim 16 in which package (1) is introduced in a roughly vertical direction.

20. Process according to claim 16 in which a package (1) presenting an elastically deformable perimeter (6) is used.

21. Process according to claim 20 in which package (1) has a flattened perimeter (6) surrounding a packaging volume (1) of product to be brewed (4).

22. Process according to claim 20 in which perimeter (6) has a central reinforcement (5) made of plastic or cardboard.

23. Device according to claim 1 comprising a follower unit (24) driven by mobile part (8) and provided with at least one groove (25) configured to receive the perimeter of package (1) when the latter has moved past the arresting means.
